(19) United States
(12) Patent Application Publication
(10) Pub. No.: US 2006/0156532 A1
(43) Pub. Date: Jul. 20, 2006

(54) Method of production of a cable press connection

(76) Inventor: Andreas Kock, Schoeppenstedt (DE)

Correspondence Address: Law Offices of Karl Hormann, P O Box 381516, Cambridge, MA, 02238-1516, US

(21) Appl. No.: 10/507,945

(22) PCT Filed: Feb. 28, 2003
(86) PCT No.: PCT/DE03/00664

§ 371 Date: Nov. 15, 2004

(30) Foreign Application Priority Data
Mar. 15, 2002 (DE) 102-11-747.0
Oct. 22, 2002 (EP) 02023506.5

(51) Int. Cl. B23Q 3/00

(52) U.S. Cl. 29/465; 29/515

(57) ABSTRACT

A method of forming a press connection between at least two adjacent cables (6, 7, 10), by pressing a sleeve (5) enclosing at least two cables (6, 7) by compression forces (K), acting approximately radially inwards on two opposing circumferential sections across more than 90 degrees of the circumference in each case, until a flowing of the sleeve material takes place.

### BACKGROUND OF THE INVENTION

1. Field of the Invention

The invention relates to a method of forming a compression connection between at least two adjacent wire cables by compressive deformation of a sleeve enclosing the at least two wire cables. Moreover, the invention relates to a method of forming a compression connection of a cable by means of a sleeve enclosing the cable in accordance with the preamble of claim 4. The invention, furthermore, relates to an apparatus for practicing the previously described methods.

2. The Prior Art

For the formation of such compressive connections it is known to use metal sleeves the cross sectional contour of which consists of two semicircular sections connected to each other by two straight sections. To form a loop, two cable strands, for instance, are inserted into such a sleeve. The sleeve is thereafter pressed under high pressure into a circular or oval shape. As a result of the pressing operation the two cable strands are pressed against each other and against the interior wall of the sleeve such that a sufficiently high frictional force is built up between wire cables and sleeve to prevent the connection from being severed even under the effect of high tensional forces. To strengthen the frictional lock further, it is known sectionally in its straight sections to reinforce the thickness of the wall of the sleeve in the direction of the interior of the wall in order to attain an embracement as large as possible of the two wire cables.

The essential drawback of all the prior art compressive deformations may be seen in the fact that the sleeves requires post-processing. Also, the cables frequently break immediately adjacent to the transition between the sleeve and the cable. Moreover, the sleeves have hitherto been complex and expensive.

### OBJECT OF THE INVENTION

It is an object of the invention to improve the previously described methods in respect of functional press connection and their costs and to propose an apparatus suitable for practicing the methods.

### BRIEF SUMMARY OF THE INVENTION

In accordance with the invention and proceeding upon the above-described methods, the object is accomplished by the sleeve, for its pressure deformation, being subjected at two opposite circumferential sections by more than 90° of circumference, to at least approximately radially inwardly directed compressive forces until the sleeve material begins to flow.

In this connection, it is useful by the pressure deformation to impart to the sleeve a polygonal, preferably hexagonal cross-sectional contour or, alternatively, a lenticular cross-sectional contour. In this manner, the sleeve is deformed from more than two directions. The deformation results in flowing of the sleeve material so that the tensile strength of the wire cables is completely maintained. The lenticular cross-sectional contour may be of non-uniform inclination, i.e. the cross-sectional configuration may be similar to that of an optical lens with a pointed edge or the cross-sectional configuration may be of a flat oval shape.

The stability may be usefully supplemented by insertion of a filler element prior to the pressure deformation of the sleeve.

Where a hexagonal cross-sectional contour is used, it is possible to round off its corners. In the case of a lenticular cross-section, the center arcuate section may be formed as a circular segment.

For supplementing the pressure deformation and for saving material, the cross-sectional contour of the interior of the sleeve may correspond to the number of wire cables to be inserted. In case two adjacent wire cables are pressure deformed an oval sleeve interior is recommended.

Sleeves of metallic materials, for instance aluminum, may be used in all instances; but non-metallic materials which preferably are capable of flowing may be used as well.

### DESCRIPTION OF THE SEVERAL DRAWINGS

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

FIG. 1 schematically depicts, in a half-open state, a pressure tool consisting of an upper tool and a lower tool including an inserted not yet compressed oval sleeve which is embracing two adjacent wire cables, the upper and lower tool each being provided with recesses which in a mirror image are alike and which together enclose a hexagonal contour;

FIG. 2 depicts the lower tool of FIG. 1 by itself;

FIG. 3 shows a lower tool according to FIG. 2, but provided a semi-lenticular recess;

FIG. 4 shows the sleeve of FIG. 1 by itself;

FIG. 5 is a cross-section of the sleeve shown in FIG. 1 after compressive deformation including the two compressed wire cables;

FIG. 6 is a representation, according to FIG. 5, of a pressed connection with an inserted or compressed filler element;

FIG. 7 is a representation according to FIG. 5 of three press connected wire cables;

FIG. 8 is the embodiment of FIG. 7 with inserted filler elements; and

FIG. 9 is a top elevational view of a loop compressive deformation.

### DETAILED DESCRIPTION OF THE PREFERRED EMBODIMENTS

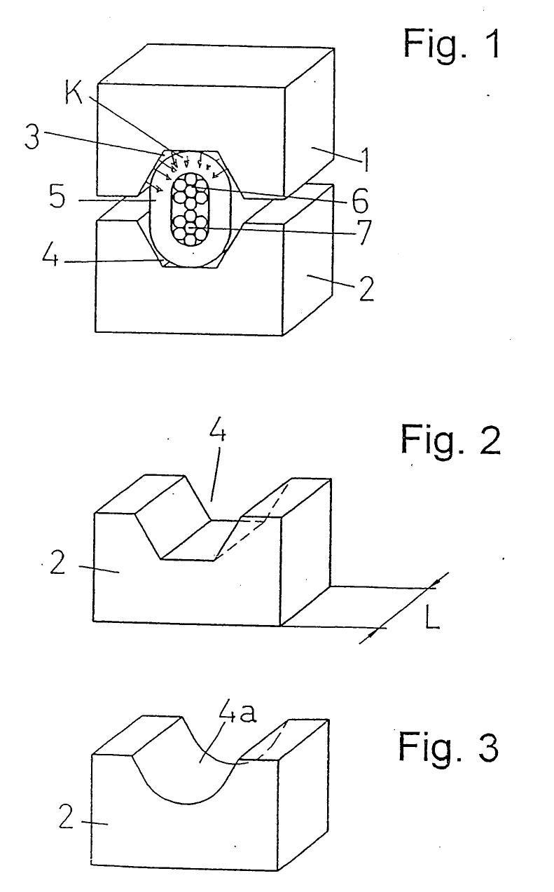

The representation according to FIG. 1 shows an open press tool which consists of an upper tool 1 and a lower tool 2 which are provided with identical, in mirror image, recesses 3, 4 which together circumscribe a hexagonal contour. Each of the two recesses 3, 4 thus corresponds to half a hexagon, that is to say that in cross-section it represents a quadrilateral with one pair of sides parallel (hereafter “trapezium”), as may be seen in FIG. 2 in connection with the lower tool 2. As an alternative to the mirror-image embodiment of the recesses 3, 4 the tools of FIGS. 2 and 3 may be combined such that the lower tool 2 corresponds to half a hexagon, whereas the associated upper tool 1 is provided with a recess 3 configured as half a lens. If desired, the cross-section of the sleeve below and above may respectively correspond to half a hexagon and half a lens. Other deviations and variants are possible.

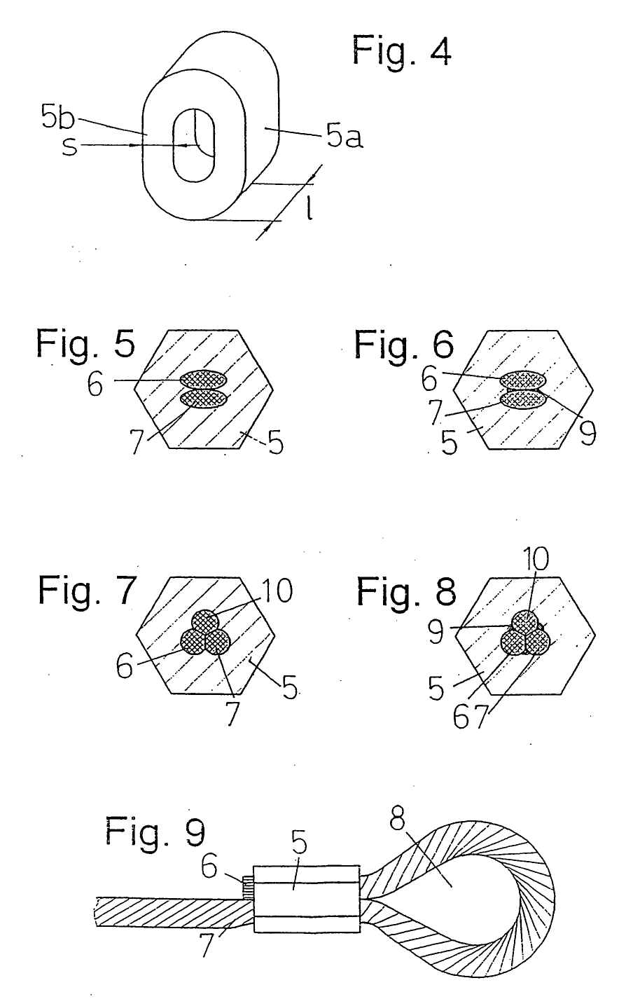

A sleeve 5 is inserted into the recess 4 of the lower tool 2. The sleeve 5 is of oval cross-section as shown in FIG. 4. This cross-sectional configuration may be composed of two semi-circles which are connected to each other by straight center sections. However, the rounded section may also be formed by an evolute. The wall thickness s of the sleeve 5 around its circumference as well as length is substantially uniform.

According to FIG. 1 the oval sleeve 5 embraces two wire cables 6, 7 positioned adjacent each other which may form a section of a common loop 8 as shown in FIG. 9.

FIG. 5 depicts a cross-section of the sleeve 5 with the two wire cables 6,7 pressure deformed by the press tool according to FIG. 1. As a result of the pressure deformation, the sleeve 5 has attained an out contour conforming to the recesses 3, 4 of the upper and lower tools 1, 2. By the pressing surfaces forming sections of a hexagon, the sleeve 5 shown in FIG. 1 at its opposite rounded sections by the closing action of the press tool is subjected to approximately radially inwardly directed compressive forces K around more than 90° of circumference. The salient point of the invention is that the compressive forces affecting the sleeve 5 during the closing action of the press tool are introduced into the sleeve 5 as radial forces not only in the upper-most and lower-most cross-sectional point but to attain a radial orientation of the compressive forces K over a larger circumferential range. This is realized by the hexagonal configuration of the pressure chamber 3,4 receiving the sleeve 5 or, alternatively, by lenticularly configured pressing chamber half of which is shown in FIG. 3 at reference character 4a as associated with the lower tool 2. Half the lens contour 4a is formed, deviating from a semi-circular configuration, is by a flat concave contour.

The compressive deformation is carried out such flowing of the sleeve material is initiated. This results in a positive connection between the sleeve and the wire cable. Where voids occur in consequence of the configuration and/or of the number of the wire cables to be connected to each other, which cannot be closed by the flowing of the sleeve material it is useful prior to pressing operation to insert at least one filler element 9 into the sleeve 9. The filler element 9 may also be introduced at any location for increasing the stability. The filler element may, for instance, be one or more wires. The position of the filler elements 9 between the wire cables 6, 7 may be fixed by adhesives or grease.

FIG. 6 depicts two wire cables 6, 7 pressed together with filler elements 9.

FIG. 7 depicts a press connection between three wire cables 6, 7, 10. No sleeve 5 of oval configuration is required for this compressive deformation; a simple tube or tube section could be used, or a sleeve the cavity of which is of even-sided triangular cross-section and the outer contour of which may even be circularly configured.

FIG. 8 also shows three press deformed wire cables 6, 7, 10 the compressive deformation was carried out with filler elements 9, however.

In order to created a softer transition for the compressively deformed wire cables 6, 7 10 at at least one end of the sleeve 5, it may be useful to apply the compressive forces K at only part of the length of the sleeve 5 the overall length of which is shown by “l” in FIG. 4. For this purpose, a press tool a 1, 2 is preferably used the axial length L of which is less than the axial length l of the sleeve 5 to be press deformed. At the end of the sleeve 5 not subjected to pressing forces, this leads to the formation of an annular ridge not shown in detail in the drawing which prevent a prevents a sharp-edged bend of the wire cable in the area of its exit from the sleeve. As an alternative to a press tool 1, 2 of short configuration, the sleeve 5 to be press deformed is not wholly inserted into the press tool 1, 2 so that a ridge is formed at one end of the sleeve 5 which was not subjected to radial compressive forces K.

The oval sleeve shown in FIG. 4 may represent a section of a drawn tube provided with this cross-sectional contour. But a section of a round tube subsequently flattened at two opposite circumferential sections 5a, 5b may also be used as a sleeve.

In order to facilitate the insertion of an end of a wire cable into the sleeve 5, the sleeve may be provided with a chamfer at at least one of its ends in a manner not shown in detail in the drawings. The chamfer at one end or at both ends of the sleeve 5 prevents a jump in the stiffness within the wire cable 6, 7, 10 thus ensuring the durability of the cable connection or compressive connection with one end piece of the sleeve. Tensile tests which have been performed have shown that before failure occurs at a compressive connection or the cable breaks at the transition between sleeve and exposed cable, the wire cable breaks in its center even though only one Compressive connection with one sleeve is used. A jump in the stiffness at the transition between the sleeve 5 and the exposed cable 6, 7, 10 is also realized by an application of compressive forces K over only part of the length of the sleeve 5 since in this manner no flow is induced in a terminal section of the sleeve 5, and the terminal section correspondingly embraces, and is filled by, the cable. The formation of a chamfer and of a collar may be carried out as alternatives or in combination.

The special shape of the upper tool 1 and of the lower tool 2 avoids any complex further machining of the compressively deformed sleeve 5 in both a lenticular and hexagonal cross-sectional configuration of the press tools 1, 2, since no sharp edges occur at the points of impact of the press tools 1, 2. In case the outwardly and inwardly flowing material of the sleeve does not completely fill the hexagonal cross-sectional mold, the resultant shape will be a desirable rounded hexagonal cross-sectional shape without any formation of burrs, so that subsequent machining becomes unnecessary.

What is claimed is:

1. A method of producing a compressive connection between at least tow adjacent wire cables (6, 7, 10) by compressive deformation of a sleeve (5) embracing the at least two wire cables (6, 7), characterized by the fact that for its compressive deformation the sleeve (5) is impacted by inwardly directed substantially radial compressive forces (K) at two opposite circumferential sections over more than 90° of circumference each.

2. The method according to claim 1, characterized by the fact that by its compressive deformation the sleeve (5) acquires a polygonal, preferably hexagonal cross-sectional contour.

3. The method according to claim 1, characterized by the fact that by its compressive deformation the sleeve (5) acquires a lenticular cross-sectional contour.

4. A method of producing a compressive connection between a wire cable (6, 7, 10) and a sleeve (5) embracing the wire cable 6, 7, 10) by compressive deformation, whereby the sleeve at two opposite circumferential sections over more than 90° of circumference is subjected to inwardly directed substantially radial compressive forces (K) until the sleeve material begins to flow, characterized by the fact that by its compressive deformation the sleeve (5) acquires a lenticular cross-sectional contour.

5. The method according to claim 4, characterized by the fact that prior to compressive deformation at least one filler element (9) is inserted into the sleeve (5).

6. The method according to claim 4, characterized by the fact that the compressive forces (K) are applied to only a partial length of the sleeve (5).

7. The method according to claim 4, characterized by the fact, that for the compressive deformation, in particular of at least two adjacent wire cables (6, 7), in particular for the compressive deformation of a loop, a sleeve (5) of substantially oval cross-section and substantially uniform wall thickness (s) is used.

8. The method according to claim 7, characterized by the fact that the sleeve (5) used is a section of a tube made of round configuration subsequently flattened at two opposite circumferential sections (5a, 5b).

9. The method according to claim 4, characterized by the use of a sleeve (5) provided with a chamfer at at least one of its two ends.

10. The method according to claim 4, characterized by the use of a sleeve of metallic material.

11. The method according to claim 4, characterized by the use of a sleeve of non-metallic material.

12. An apparatus for practicing the method of one of the preceding claims, characterized by a two-part press tool for compressively deforming the sleeve (5), the upper and lower tool (1, 2) of which are each provided with a recess (3, 4) identical in mirror image which together embrace a hexagonal or lenticular contour.

13. The apparatus or claim 12 for practicing the method, characterized by the fact that the axial length (L) of the press tool (1, 2) is less than the axial length (l) of the sleeve (5) to be compressively deformed.
